(19) United States
(12) Patent Application Publication
(10) Pub. No.: US 2011/0097443 A1
(43) Pub. Date: Apr. 28, 2011

(54) Low glycemic sweeteners and products made using the same

(76) Inventors: Ting Liu Carlson, Dayton, OH (US); Dan McElwee, Troy, OH (US); Michael A. Remmert, Romeoville, OH (US); Chin Hong Paul Kim, Plymouth, MN (US); Sharon Walbert, Glen Ellyn, IL (US); Anton Woo, Huber Heights, OH (US)

(21) Appl. No.: 10/592,738

(22) PCT Filed: Mar. 17, 2005
(86) PCT No.: PCT/US05/09114

§ 371 Date: Nov. 6, 2008

Related U.S. Application Data
(60) Provisional application No. 60/553,864, filed on Mar. 17, 2004.
(60) Provisional application No. 60/553,913, filed on Mar. 17, 2004.
(60) Provisional application No. 60/554,823, filed on Mar. 18, 2004.

(51) Int. Cl. A23G 3/36; A23L 2/00; A23L 1/302

(52) U.S. Cl. 426/48; 426/658; 426/590; 426/72

(57) ABSTRACT

This invention relates to food products and methods of making food products containing low-glycemic sweeteners (LGS), as well as blends containing LGS.

### FIELD OF THE INVENTION

This invention relates to food products and methods of making food products containing low-glycemic sweeteners (LGS), as well as blends containing LGS.

### BACKGROUND OF THE INVENTION

Typical corn syrups that are useful in the production of beverages, sports drinks, and other food applications are known. It would be desirable, however, to have available for use in beverages, sports drinks, and other food applications, as required, a product having sweetness similar to that of corn syrups, with functionality similar to typical corn syrups, and having a lower glycemic index.

### SUMMARY OF THE INVENTION

Disclosed herein are compositions that release glucose over a sustained period of time as well as processes for preparing new and improved food products such as animal feed, beverages, bakery products, confectionery products, condiments, and snacks, characterized by having sweetness and a lower glycemic index. Glycemic index is correlatable with glucose release and can be tested using the procedure provided in Example 5, below.

The low-glycemic sweeteners (LGS) described herein are prepared by reacting sucrose and an acceptor selected from the group consisting of a sugar or a sugar alcohol having free hydroxyl groups at one or more of carbon positions numbers 2, 3 and 6 that can accept a glucose unit from sucrose, with a glucansucrase enzyme. As used herein LGS refers to products resulting from the reaction that comprise fructose and various glucose oligosaccharides.

Also included within the present invention, are the foods and beverages that utilize as a sweetener, at least one or more LGS prepared by reacting a blend, of sucrose and an acceptor selected from the group consisting of a sugar or a sugar alcohol having free hydroxyl groups at one or more of carbon positions numbers 2, 3 and 6 (also referred to as the C-2, C-3 and C-6 positions) that can accept a glucose unit from sucrose, with a glucansucrase enzyme. Also included are foods and beverages that comprise LGS and one or more additional compounds, such as conventional sweeteners (including those described below), sugar alcohols (including those described below), high intensity sweeteners (including those described below), flavors, flavor enhancers, vitamins and/or minerals. Such blends can be made and sold to formulators or the individual ingredients can be sold to a formulator and blended as part of the process of making food products and/or supplements.

In another embodiment the invention provides blends of natural sweeteners such as natural high intensity sweeteners with sugar alcohols. For example the natural sweetener monatin can be blended with one or more sugar alcohols such as erythritol.

Another aspect of the invention comprises food products that include at least one LGS that results in a food product that has at least 10%, 20%, 40% or 50% lower glycemic index than the glycemic index of a control food product that is made using conventional sweeteners. In some embodiments the LGS is made by reacting sucrose and an acceptor, such as maltose, at a ratio of at least about 4:1 in the presence of a glucansucrase enzyme, such as the enzyme isolated from Leuconostoc mesenteroides (LM) strain NRRL-B-21297. In additional embodiments the LGS is made by reacting sucrose and an acceptor in a ratio of from about 8:1 to about 11:1.

These and other objects and advantages of the present invention will be apparent to those skilled in the art from the following detailed description and claims.

### DETAILED DESCRIPTION OF THE INVENTION

In accordance with the present invention, it has been found that the above and still further objects are achieved by utilizing a LGS in the making of food products (including pharmaceutical items such as cough syrups and the like). Glycemic index is correlatable with glucose release. The making and use of LGS is described below. Throughout the description provided herein the use of the term “LGS” refers to sweeteners made as described above which vary somewhat depending on the reaction conditions used to make them. Moreover when LGS is referenced in the description it should be understood to mean one or more products made by the process described herein, unless a specific process of making a specific LGS is otherwise identified.

### Making the LGS

The acceptor and sucrose are reacted with a glucansucrase enzyme that will transfer glucose units from sucrose to an acceptor carbohydrate and will release fructose and glucose oligosaccharides of various lengths. The resultant product may have a level of sweetness similar to that of a corn syrup, and a mouth-feel and functionality similar to that of corn syrup. In addition, and more significantly for the present process, the resulting product is characterized by having a lower glycemic index as compared to the combination of the reactants (sucrose and acceptors) that are not reacted with enzyme.

The acceptor can be selected from the group consisting of a sugar or a sugar alcohol having free hydroxyl groups at one or more carbon position numbers 2, 3 and 6 that can accept a glucose unit from sucrose. The acceptor can be in the form of syrup or syrup solids. Exemplary of the syrups or syrup solids suitable for use herein are maltose, maltotriose, panose, high maltose (over 40%) corn syrup, medium to low DE (dextrose equivalent) corn syrup, raffinose, cellobiose, maltitol, maltotriose, maltotetrose, glucose, isomaltose, isomaltitol, barley syrup and syrup solids, rice syrup and syrup solids, lactose, whey permeate, tapioca starch syrup and syrup solids, nigerose, kojibiose, isomaltooligosaccharide, hydrogenated starch syrup, potato starch syrup and syrup solids, corn syrup and syrup solids, and the like. Exemplary of the syrups that are suitable for use in the blends are, but not limited to, SATINSWEET™, available from Cargill, Incorporated, that contains minimal 55 to 70 weight % maltose and 45 to 30% weight % of glucose and other glucose-containing oligomers. In a preferred embodiment, the syrup or syrup solids used herein comprise an amount of from about 2 to about 99% by weight of maltose.

The glucansucrase enzymes that can be used in the reaction to produce the LGS include, but not limited to, LM strains NRRL-B 1121, 1143, 1149, 1254, 1297, 1298, 1355, 1374, 1375, 1377, 1399, 1402, 1433, 23185, 23186, 23188, 23311, 742, 523, 21297, and other enzymes provided herein. These strains can be cultured and the enzymes can be isolated using any method known in the art, such as the method provided below. For example, a process for producing the LGS suitable for use herein comprises reacting, or incubating, blends of sucrose and syrup or syrup solids, as an acceptor carbohydrate, in varying ratios of components, in a total sugar concentration of from about 2 to about 40%, with an amount of the glucansucrase from LM and other lactic acid bacteria, sufficient to provide a low glycemic index product. The reaction, or incubation, is carried out at a temperature of about 30° C. to about 45° C., for a period of about 1 to about 48 hours.

The characteristics of the LGS can be altered by controlling the ratio of sucrose to acceptor. Generally, the glycemic index of the product produced will decrease as the ratio of sucrose to acceptor increases. For example, it is expected that a product made using a ratio of 1:1 (sucrose to acceptor) will have a higher glycemic index than that of a product created using a ratio of 4:1 (sucrose to acceptor). Therefore, the invention provides methods of making LGS using ratios of sucrose to acceptor of at least 4:1, 5:1, 6:1, 7:1, 8:1, 9:1, and 10:1. Accordingly, the invention also provides food products made by such methods.

In some embodiments where it is desirable to use LGS that has a particularly low glycemic index the LGS can be made using a ratio of from about 8:1 to about 11:1 or by using a ratio of from about 9:1 to about 10:1 (sucrose to acceptor). It has been found that the digestibility of the LGS increases when the LGS is made outside of these ranges (see Example 4).

The LGS can also be characterized by the linkages between the glucose molecules in the glucose oligosaccharide. In some embodiments the glucose oligosaccharide has both alpha 1,3 and alpha 1,6 linkages, and the glucose oligosaccharide product may also contain, but is not limited to, other linkages such as alpha 1,4. In some embodiments the LGS will have at least 20% alpha 1,3 linkages and in other embodiments the LGS will have at least 20% alpha 1,3 linkages and at least 20% alpha 1,6 linkages.

The LGS can also be subsequently processed to remove a portion of, or all of, the fructose, thus yielding a LGS that is fructose depleted. Fructose can be removed from the LGS using any method known in the art, for example by using column chromatography. Generally, the LGS contains less than 50% fructose.

More specifically, the LGS can be made from syrups that contain one or more acceptors. When the acceptor used is in the form of a syrup it can be blended using any technique known in the art. For example the blends may be produced by physical mixing of the sucrose and the syrup or syrup solids. As used in the examples herein, the blends of sucrose and syrup or syrup solids were produced by blending. In several of the examples herein, there are exemplified blends of sucrose and corn syrup comprising about 65 weight percent maltose (SATIN-SWEET™ 65) comprising sucrose to SATIN-SWEET™ 65 corn syrup in ratios of 3:2, 2:1, and 5:2 on a dry weight basis. However, as mentioned herein, any ratio of sucrose to syrup or syrup solids such as from about 20:1 to 1:20 sucrose to syrup or syrup solids, may be used that allows a low glycemic index product to be obtained. More precisely, in several of the examples, there was utilized SATINSWEET™ 65 corn syrup, a trademarked product available from Cargill, Incorporated that contains minimal 65% by weight maltose and 35% by weight glucose and other glucose-containing oligomers.

### Uses of the LGS

The LGS described herein, and exemplified in the Examples are expected to be useful in the preparation of food and beverage compositions characterized by having a lower glycemic index than food products made using conventional sweeteners. It is expected that the LGS as described herein may be successfully incorporated as sweeteners in any food product where conventional sweeteners are used, including animal feed, beverages, confectioneries, condiments, energy drinks, chewing gum, ice cream, desserts, pet food, and the like, where it is desired to produce low glycemic foods or drinks. The LGS may be incorporated in the food or beverage compositions in any desired amount, depending on the specified application. For example, the LGS may be incorporated in an amount ranging from about 0.1 to about 99.9% by weight of the food or beverage composition.

Food products containing the LGS will generally have a glycemic index that is at least 10% lower than the glycemic index of a substantially similar product made using conventional sweeteners. Conventional (nutritive) sweeteners as used herein refers to sucrose-based sweeteners, such as granulated sugar, liquid sugar, and brown sugar, starch-based sweeteners, such as dextrose-based products including maltodextrin, corn syrup and corn syrup solids, and dextrose, fructose-based products including high fructose corn syrup and crystalline fructose, and other starch-based products such as maltose and malt syrup. Other specialty sweeteners are also used including honey and artificial honey, lactose, maple syrup and maple sugar, and fruit-derived sweeteners.

LGS disclosed herein can be blended with one or more of a variety of other ingredients and sold to formulators as blends, or the components for the blends can be provided to the formulator separately and the formulator can blend them while making a final food product. LGS can be blended with one or more other ingredients such as vitamins, minerals, sugar alcohols, high intensity sweeteners, flavors, flavor enhancers, and other conventional sweeteners to provide the desired nutritional impact as well as the desired flavor. The creation of blends with LGS is expected to improve the homogeneity of the end product.

Vitamins that can be blended with LGS include any of a group of organic substances other than proteins, carbohydrates, fats, minerals, and organic salts which are essential for normal metabolism, growth, and development of the body. Vitamins include compounds such as A, D, E, K, biotin, choline, folic acid, and nicotinic acid.

Mineral compounds that can be blended with the LGS sweeteners include inorganic compounds of mineral elements, which constitute the mineral constituents of the body. Mineral salts and water are excreted daily from the body and, therefore, need to be replenished. These must be replaced through food or supplement intake. Examples of minerals include Ca, Fe, P, Na, Cu, I, and Mg.

Flavors and/or flavor enhancers can be also blended with LGS. For example dihydroxybenzoic acid (DHB, including all isomers) as well as flavors such as peppermint, cocoa, and vanilla.

Sugar alcohols can be blended with LGS and used to impart sweetness to a particular food product and in many instances the sugar alcohol will not contribute as greatly to the caloric content of the product when compared to conventional sweeteners. Sugar alcohols are characterized by the presence of a hydroxyl group on a ketose sugar or hexose sugar. Examples of sugar alcohols that can be blended with the LGS sweeteners described herein include sorbitol, mannitol, xylitol, lactitol, maltitol, isomalt, hydrogenated starch hydrolysate, and erythritol.

LGS disclosed herein can also be blended with high-intensity sweeteners. High-intensity sweeteners are agents that exhibit sweetening powers at very low concentrations. Examples of high-intensity sweeteners that can be blended with the LGS compositions described herein include saccharin, cyclamate, aspartame, monatin, alitame, acesulfame potassium, sucralose, thaumatin, stevioside, and glycyrrhizin.

The invention will be more readily understood by reference to the following examples. There are, of course, many other forms of this invention which will become obvious to one skilled in the art, once the invention has been fully disclosed, and it will accordingly be recognized that these examples are given for the purpose of illustration only, and are not to be construed as limiting the scope of this invention in any way.

### EXAMPLES

Examples 1 and 2, provided below teach how to make the LGS described herein. Additionally, the examples described below provide results showing that the LGS described herein is low-glycemic. This is shown by in vitro experimentation using glucoamylase assays to estimate glycemic index (Example 3, Studies 1-3), and experimentation using rat intestinal powder to estimate glycemic index (Example 4) and finally through human clinical trials (Example 5). Example 6 provides the results relating to LGS made with various enzymes, and example 7 provides food compositions that are created using LGS.

### Example 1

### Method of Preparing Enzymes

LM strain NRRL-B-523 or NRRL-B-21297 was cultured in a 200-liter fermenter at 30° C. with mixing at 150 revolutions per minute (rpm) in a medium containing 0.22 weight % Hy Pep 1510 (enzymatic hydrolysis of soy), 0.22 weight % HY-YEST 412 (spray-dried extract from primary grown baker's yeast), both available from Quest, International, Hoffman Estates, Ill., 0.2 weight % ammonium citrate, 0.5 weight % sodium citrate, 0.01 weight % magnesium sulfate, 0.005 weight % manganese sulfate and 0.2 weight percent potassium phosphate (dibasic) supplemented with 2 weight percent sucrose and 2 weight percent SATIN-SWEET™ 65 corn syrup comprising 65 weight percent maltose for 18 hours. The resulting cultural supernatant was clarified by filtration of the supernatant through 0.1 micron Amicon hollow fiber filters, available from Millipore, Bedford, Mass., at 4° C. Enzyme from the clarified supernatant was purified and concentrated from other medium components by ultra filtration through a 50,000 kD molecular weight Pellicon-2 polyethersulfone cassette diafiltration membrane, available from Millipore, Bedford, Mass. 20 liters of enzyme solution was obtained, which is 10-fold concentrated as compared to the starting cultural supernatant.

### Example 2

### Various Acceptors Useful for Producing LGS

Enzyme from the LM NRRL-B-21297 strain was tested to determine the suitability of various acceptors. Enzyme was prepared using the methods described herein.

In determining the suitability of the preparation of the sucrose/acceptor products, 0.4% by weight of each sucrose and acceptor were mixed with enzyme solution in 0.01 M sodium gluconate buffer, pH 6, and the reaction proceeded for 2 hours at 37° C.

The carbohydrate profiles of products generated by the enzyme reactions with the blends of sucrose and syrups and syrup solids herein, were analyzed by high performance liquid chromatography (HPLC) using two (2) Bio-Rad Aminex HPX-42A carbohydrate columns (300 mm×7.8 mm) available from Bio-Rad, Hercules, Calif., in succession, with water as the eluate at 0.2 ml/min, at a temperature of 65° C.

The reaction rate was estimated based on the amount of oligosaccharides generated from each acceptor and normalized against the fructose concentration in each reaction. The results are reported below in Table 2.0. The values reported for oligosaccharides to fructose are for DP3-DP7 minus starting material.

TABLE 2.0

| Example | | Weight Ratio of |
|---|---|---|
| Number | Acceptor | Oligosaccharide to Fruct |
| 1 | Maltose | 2.02 |
| 2 | Panose | 1.56 |
| 3 | Isomaltose | 0.93 |
| 4 | Maltotriose | 0.53 |
| 5 | Maltotetrose | 0.38 |
| 6 | Glucose | 0.49 |

From the data it is observed that maltose is the best acceptor for the enzyme from strain NRRL-B-21297, followed by panose and isomaltose.

As part of this evaluation, other sugars were evaluated for suitability as acceptors. The sugars were xylose, arabinose and myo-inositol. These sugars were found to be not as effective acceptors as the acceptors listed in Table 2.0 within the two (2) hour reaction time.

### Example 3

### In Vitro Studies Using Glucoamylase to Estimate Glycemic Index

The three studies described below provide data relating to the carbohydrate profiles of the various LGS, as well as the glycemic index estimate (as identified using glucoamylase and HCl) of the various LGS.

A. Study 1

LM strain NRRL-B-21297 was cultured as described above, and the recovered enzymes were resuspended in 0.01 M gluconate buffer (pH 6), up to the original supernatant volume, together with 8% by weight of total sugars, in ratios of 3:2, 2:1; and 5:2, of sucrose to SATIN-SWEET™ corn syrup containing 65 weight % maltose (65HM herein). The enzyme reaction was allowed to proceed for 16 hours at a temperature of 37° C., with mild agitation.

At the completion of the reaction, the resultant products were analyzed by the HPLC method described herein.

The resulting three (3) products contain the sugar profiles reported in Table 3.0.

TABLE 3.0

| | Suc/65 HM ratio | | |
|---|---|---|---|
| | 3:2 | 2:1 | 5:2 |
| Higher | 0.97 | 0.79 | 0.69 |
| DP8 | 0 | 0.82 | 1.45 |
| DP7 | 1.56 | 2.74 | 3.92 |
| DP6 | 3.02 | 5.13 | 6.76 |
| DP5 | 12.01 | 15.1 | 16.1 |
| DP4 | 20.49 | 19.27 | 16.89 |
| DP3 | 24.47 | 16.32 | 11.21 |
| Maltose | 3.87 | 1.66 | 0.84 |
| Glucose | 2.97 | 3.87 | 4.9 |
| Fructose | 30.64 | 34.28 | 37.24 |

*Table 3.0. Carbohydrate profiles of L. mesenteroides B-21297 enzymes incubated with sucrose and SATIN-SWEET ™ 65 corn syrup at three ratios. Numbers represent percentages of total carbohydrates in the final product. Abbreviations: DP = degree of polymerization; higher = sugars with a DP > 8.

To obtain an estimate of the glycemic index of the products, in vitro digestibility assays, using glucoamylase and acid hydrolysis to simulate digestion, were performed. An amount of 0.08% of glucoamylase, (v/v) available from Genencor, Rochester, N.Y., under the tradename, Optidex L-400, was used at a temperature of 37° C., for a period of 1 hour, with mild agitation. The reactions were stopped by the addition of hydrochloric acid (HCl) to a final concentration of 0.24M (molar), and heating at 90° C. for a period of 5 minutes. The amount of glucose released was measured by HPLC using an Aminex HPX-87H ion exclusion column, available from Bio-Rad, with 0.01N (normal) sulfuric acid as the mobile phase.

The results are reported in Table 3.1 below.

TABLE 3.1
(% Glucose Release)*

| | | Low glycemic sweetener |
|---|---|---|
| | Control Product without | after glucansucrase |
| suc/65HM | glucansucrase treatment | treatment |
| 3:2 | 100.00% | 36.10% |
| 2:1 | 100.00% | 28.70% |
| 5:2 | 100.00% | 38.70% |

*Table 3.1. Amount of oligosaccharides present in products generated by L. mesenteroides B-21297 enzymes and their respective glucose release values as determined by the in vitro digestibility assays with glucoamylase.

From the data in Tables 3.0 and 3.1, it is observed that the three products comprising blends of sucrose and corn syrup containing 65 weight % maltose, in varying ratios, are sweet, since the content of fructose ranges from about 30 to about 37%. Furthermore, it is expected that the three products will be low glycemic, and will possess unique mouth-feel and functionality in various food and beverage applications.

Study 2

Cultural supernatant of LM NRRL-B-21297 was used to convert blends of sucrose and corn syrup or corn syrup solids containing either 65 weight % maltose (65HM), or 96 weight % maltose (96HM), to LGS. In so doing, a total of 20 weight %, or 30 weight %, sugars in water, of various ratios of sucrose to acceptor, containing either 65 or 96 weight percent maltose, were incubated with 10 weight % of concentrated enzyme solution, at a temperature of 37° C. for a period of about 16 hours. Enzyme activity was inactivated by heat treatment at a temperature of 121° C. for a period of 10 minutes. The resulting syrups were filtered through 0.7 micron glass fiber filter (Pall Corporation, Ann Arbor, Mich.), treated with activated carbon, and treated with cation and anion exchange resins to remove color, protein, and ions. The products were filtered through Whatman No. 3 filter paper (Whatman International, Ltd. Maidstone, England) to remove carbon fines. The resulting LGS were then evaporated at a temperature of 70° C. to 80% dry solids.

The carbohydrate profiles of the resulting LGS are reported in the following Table 3.2.

TABLE 3.2

| | 3:2 SUC/65HM | 3:1 suc/65HM | 3:2 suc/96HM | 2:1 suc/96HM | 7:2 suc/65HM |
|---|---|---|---|---|---|
| | LGS1 | LGS2 | LGS3 | LGS4 | LGS5 |
| DP7+ | 5 | 11 | 1 | 0 | 18 |
| DP6 | 4 | 9 | 3 | 4 | 10 |
| DP5 | 14 | 17 | 14 | 14 | 10 |
| DP4 | 23 | 14 | 29 | 24 | 12 |
| DP3 | 18 | 9 | 15 | 10 | 6 |
| Maltose | 2 | 1 | 3 | 0 | 1 |
| Glucose | 4 | 3 | 2 | 15 | 6 |
| Fructose | 30 | 36 | 33 | 33 | 37 |

Numbers represent percentages of total carbohydrates in the final product. Abbreviations: DP = degree of polymerization

By using the in vitro digestibility assay described above, the relative glucose release rate as compared to starting sugar mixtures without enzyme treatment is shown below for the LGS, identified as LGS1 through LGS5. The results of the glucose release assays are reported in Table 3.3.

TABLE 3.3

% glucose release

| Product | w/w sugar | Control | LGS |
|---|---|---|---|
| LGS1 | 3:2 suc:65HM | 100 | 38 |
| LGS2 | 3:1 suc:65HM | 100 | 19 |
| LGS3 | 3:2 suc:96HM | 100 | 30 |
| LGS4 | 2:1 suc:96HM | 100 | 17 |
| LGS5 | 7:2 suc:65HM | 100 | 23 |

From the data in Tables 3.2 and 3.3, it is observed that the products of the present invention are sweet, having a fructose content ranging from 30 to 37 weight %, and that the products of the present invention are characterized by having reduced glucose release rate compared to products produced in the absence of the reaction with the enzyme. Thus, the products of the present invention are expected to have a lower glycemic index.

Study 3

In this example, there were provided two products from blends of sucrose and corn syrup solids containing 96 weight % maltose in the ratio of 3:2, sucrose to corn syrup solids.

Enzymes were obtained from LM strains NRRL-B-523 and NRRL-B-742 using the procedures provided above. The enzyme reaction was carried out using the same procedure as described in Studies 1, with the exceptions that the enzymes differ and the blend of sucrose and acceptor differ from that used in Example 1.

The carbohydrate profile of the resulting two (2) LGS are reported in Table 3.4.

TABLE 3.4

| | B-523 | B-742 |
|---|---|---|
| DP5 | 1 | 1 |
| DP4 | 5 | 5 |
| DP3 | 24 | 30 |
| Maltose | 23 | 18 |
| Glucose | 19 | 15 |
| Fructose | 29 | 29 |

Numbers represent percentages of total carbohydrates in the final product. Abbreviations: DP = degree of polymerization

With respect to the two (2) LGS of Example 3, in vitro digestibility assays described above, were carried out to compare the percent glucose that was released in the enzyme treated LGS with the percent glucose released in the starting blend of sucrose and corn syrup solids containing 96 weight percent maltose that was not reacted with the enzyme. It was determined that the in vitro digestibility showed a glucose release rate of 41% for the product prepared using the strain LM NRRL-B-523 enzyme, and 40% for the product prepared using the strain LM NRRL-B-742 enzyme, as compared to the control syrup solids blend without enzyme treatment, where the glucose release is 100%.

Therefore, it is apparent that the products of Example 3 are estimated to have a lower glycemic index than that of the starting blend of sucrose and corn syrup solids. It is expected that the products of Example 3 will be useful in the preparation of food and beverage compositions having low glycemic index.

### Example 4

### In Vitro Studies Using Rat Intestinal Powder

A. Initial Results

The initial results provided in this example are derived from in vitro digestibility assays using rat intestinal powder available from Sigma/Aldrich, Saint Louis, Mo., Catalog Number 1-1630). In each reaction, 2% by weight of total carbohydrate was mixed with 1.25 weight % of rat intestinal powder in 0.025M phosphate buffer, at pH of 6.5 and incubated at 37° C. for up to 12 hours. Free glucose concentration in the reaction mixture was analyzed over time by the HPLC method described above.

LGS were made using enzyme preparations from LM NRRL-B-21297, as described above. The resulting reaction products have sucrose to maltose weight ratios of 1:1, 1.5:1, 2.33:1, 4:1, 9:1, and 19:1. The reaction products were tested in the in vitro digestibility assay described above, which used rat intestinal powder. The results of the evaluation are reported below in Table 4.0.

TABLE 4.0

| | | % Theoretical | % Theoretical | % Theoretical | % Theoretical |
|---|---|---|---|---|---|
| Example | Sucrose/ | Glucose | Glucose | Glucose | Glucose |
| NO. | Maltose | 0 hr | 4 hrs | 8 hrs | 12 hrs |
| 1 | 1:1 | 1.32 | 65.20 | 82.20 | 88.00 |
| 2 | 1.5:1 | 1.73 | 66.25 | 86.00 | 90.75 |
| 3 | 2.33:1 | 1.80 | 45.27 | 58.89 | 65.59 |
| 4 | 4:1 | 2.15 | 33.50 | 46.00 | 50.75 |
| 5 | 9:1 | 2.73 | 23.22 | 30.60 | 29.78 |
| 6 | 19:1 | 4.00 | 24.00 | 28.57 | 24.86 |

As a comparison, maltose is 88% digested in 4 hours using this method of assay.

In Table 4.0, the free glucose concentration in the reaction mixture was analyzed over time by the HPLC method described herein. The results in Table 4 show that the higher the sucrose to maltose weight ratio, the lower the digestibility. From the data, it appeared that the digestibility value reached a plateau when the sucrose to maltose weight ratio is 9:1 and greater. Moreover, the results indicate that the product is low-glycemic.

B. Additional Results

Further assays involved repeating the above rat intestinal assay to further identify the specific reaction parameters. These additional assays were done using LGS made with various ratios of sucrose to maltose. These assays contained 2 ml of 4% LGS, 2 ml of 0.05 M phosphate buffer, pH=6.5, and 0.1 g of rat intestinal powder. The incubation was done at 37° C. for 4 hours and the amount of glucose released into the medium was determined by HPLC.

Surprisingly, the results showed that there is a preferred range of sucrose to maltose ratios which produced the least digestible glucose in 4 hours. Furthermore, as the ratio of sucrose to maltose increases, the amount of polysaccharides in LGS also increases. The polysaccharide portion generates turbidity in LGS, which makes the syrup more viscous. Using this preferred range allows for the production of LGS syrups that are suitable for most food applications and at the same time generate the least glycemic response.

TABLE 4.1
In vitro digestibility assay

| In vitro digestibility assay | % glucose released in 4 hours | | | |
|---|---|---|---|---|
| sucrose to maltose ratio | 1st study | 2nd study | 3rd study | Ave. |
| 1:01 | 88 | 79.1 | | 83.6 |
| 2:01 | 67 | | | 67 |
| 3:01 | 67.8 | | | 67.8 |
| 4:01 | 56.7 | 37.5 | | 47.1 |
| 5:01 | 43.6 | | | 43.6 |
| 6:01 | 44.3 | | | 44.3 |
| 7:01 | 33.4 | | 32.7 | 33.1 |
| 8:01 | 29.9 | 28.1 | 32 | 30 |
| 9:01 | 32.7 | 28.6 | 29.5 | 30.3 |
| 10:01 | 30.9 | 29.6 | 29.2 | 29.9 |
| 11:01 | 33.8 | | 29.6 | 31.7 |
| 12:01 | 34.2 | | | 34.2 |
| 13:01 | 32.9 | | | 32.9 |
| 14:01 | 35 | | | 35 |
| 15:01 | 34.4 | | | 34.4 |
| 16:01 | 33.8 | | | 33.8 |
| 17:01 | 34.9 | | | 34.9 |
| 18:01 | 35.1 | | | 35.1 |
| 19:01 | 35.3 | 36.4 | | 35.9 |
| 39/1 | 38.4 | | | 38.4 |

### Example 5

### In Vivo Studies of Glycemic Response to LGS in Humans

Samples were initially tested to determine their carbohydrate profile, prior to determining their in vivo glycemic effect. The control in the human trial was 42 high fructose corn syrup (REVS). The LGS used were produced using enzymes isolated from LM NRRL-B-21297 in reactions with sucrose and maltose in ratios of 9:1 and 4:1 (LGS 9:1 and LGS 4:1).

Study 1—Carbohydrate Profile

The carbohydrate profiles were generated using the methods described above. The results are shown in Table. 5.0.

TABLE 5.0

| | Sweetener composition for in vivo study | | |
|---|---|---|---|
| | 42 HFCS | LGS 4:1 | LGS 9:1 |
| DP12+ | | 4.1 | 6.9 |
| DP12 | | 1.7 | 3.9 |
| DP11 | | 4 | 7.9 |
| DP10 | | 4.7 | 5.5 |
| DP9 | | 6.3 | 9.8 |
| DP8 | | 5.22 | 4.9 |
| DP7 | | 6.5 | 5.9 |
| DP6 | | 4.3 | 2.9 |
| DP5 | | 4.7 | 1.4 |
| DP4 | 1 (DP4+) | 4.2 | 0.7 |
| DP3 | 1 | 6.4 | 1.1 |
| DP2 | 2.9 | 5.2 | 1.9 |
| DP1 | 51.5 | 6.2 | 9.5 |
| Fructose | 43.6 | 36.5 | 37.8 |

Numbers represent percentages of total carbohydrates in the final product.
Abbreviations: DP = degree of polymerization

Study 2—In Vivo Assay

The method of testing the glycemic index provided in Wolever, et al. Nutrition Research 23:621-629, 2003, which is herein incorporated by reference, was used in the following study. More specifically, three different samples where prepared for evaluation by 10 healthy human subjects. The first sample is a drink comprising 50 grams on dry weight basis, of the LGS having an initial sucrose to maltose weight ratio of 9:1, and 200 grams water.

The second sample is a drink comprising 50 grams, on dry weight basis, of the LGS having an initial sucrose to maltose weight ratio of 4:1, and 200 grams of water.

The third sample is a drink comprising 50 grams, on dry weight basis of 42 high fructose corn syrup that contains 42% fructose and 200 grams water.

Each of the three (3) drinks were consumed by 10 human subjects, on three (3) separate times.

The drinks containing the LGS were found to produce a smaller rise in blood glucose response when compared to the drinks containing 42 high fructose corn syrup as a sweetener. More particularly, assuming a rise in blood glucose value (area under the curve) of 100% for the drink containing the 42 high fructose corn syrup used as the control, the value resulting from the drink containing the LGS having an initial sucrose to maltose weight ratio of 4:1 is 89% of the control, and the value resulting from the drink containing the LGS having an initial sucrose to maltose weight ratio of 9:1 is 55% of the control. These results, indicate that the LGS described herein; having the weight ratios of 4:1 and 9:1 are low glycemic index products. Moreover, the data indicates that the low-glycemic sweetener having a weight ratio of 9:1 is a more effective in lowering the glycemic index of a food product, than the LGS having a weight ratio of 4:1.

### Example 6

### LGS Produced from other LM Strains

The following LM strains were obtained from the Agricultural Research Service Culture Collection (USDA) NRRL-B: 1121, 1143, 1149, 1254, 1297, 1298, 1374, 1375, 1377, 1399, 1402, 1433, 23185, 23186, 23188, and 23311. Fifty-milliliter cultures were grown using LM media (which is the media described in Example 1, except HyPep and Hy-yest are replaced by 0.15% polypeptone, 0.15% beef extract and 0.15% yeast extract) supplemented with sucrose and maltose (4% total sugar) at a 2 to 1 ratio. Cultures were grown at 32° C. with agitation for 20 h. Sugar profiles were identified by HPLC, as previously described. Specific strains were further grown as 1 L cultures using the same media and cells were harvested by centrifugation. The remaining supernatants were passed through a 50 K molecular weight cut-off filtration unit to generate a concentrated enzyme preparation (7-10× concentrate). Enzyme preparations were used to produce LGS (5% total sugar at 9:1 sucrose to maltose) and in vitro digestibility assays were performed as previously described.

The enzymes were prepared using the methods described above and 9:1 sucrose to acceptor ratios, except for the 1254 strain noted.

TABLE 6.0
Table 6.0. Summary of sugar profiles of syrups generated by concentrated
Leuconostoc cell-free extracts with 5% sucrose and maltose at a 9:1 ratio.

| | | | | 1254- | | | |
|---|---|---|---|---|---|---|---|
| | 21297 | 1121 | 1254 | 5:1* | 1298 | 1374 | 1375 |
| polymer | 5.68 | 3.27 | 0 | 0 | 0.97 | 0 | 0 |
| DP14+ | 0 | 1.07 | 0 | 0 | 4.54 | 0 | 0 |
| DP13 | 0 | 0.01 | 0 | 0 | 0.08 | 0 | 0 |
| DP12 | 0 | 0 | 0 | 0 | 0 | 0 | 0 |
| DP11 | 6.41 | 0.01 | 0 | 0 | 0 | 0 | 0.07 |
| DP10 | 3.06 | 0.08 | 0 | 0 | 0 | 0.80 | 0.14 |
| DP9 | 8.44 | 0.54 | 0.13 | 0.1 | 0.01 | 0.73 | 0.24 |
| DP8 | 6.59 | 0 | 0.23 | 0.18 | 0.1 | 1.1 | 0.64 |
| DP7 | 9.94 | 1.83 | 0.75 | 0.68 | 0.5 | 1.95 | 2.50 |
| DP6 | 7.51 | 7.21 | 2.49 | 2.56 | 2.16 | 4.41 | 0.00 |
| DP5 | 5.97 | 11.44 | 7.38 | 8.44 | 4.91 | 8.26 | 7.92 |
| DP4 | 2.33 | 9.88 | 10.93 | 14.79 | 6.15 | 8.99 | 13.85 |
| DP3 | 2.37 | 6.61 | 8.47 | 12.36 | 6.72 | 3.49 | 5.60 |
| DP2 | 0.09 | 2.78 | 1.07 | 0.83 | 4.36 | 0.95 | 0.58 |
| DP1 | 2.87 | 16.33 | 14.49 | 10.12 | 21.8 | 3.32 | 11.1 |
| FRU | 38.22 | 38.86 | 39.49 | 39.85 | 47.61 | 37.3 | 33.38 |

| | 1377 | 1402 | 23185 | 23186 | 23188 | 23311 |
|---|---|---|---|---|---|---|
| polymer | 0 | 12.27 | 14.97 | 40.85 | 30.78 | 22.26 |
| DP14+ | 0 | 2.80 | 9.30 | 0 | 8.05 | 9.73 |
| DP13 | 0 | 0 | 2.03 | 0.35 | 0 | 0 |
| DP12 | 0.33 | 6.44 | 0 | 0.62 | 0 | 3.25 |
| DP11 | 0 | 5.01 | 0.58 | 0.09 | 1.08 | 2.51 |
| DP10 | 0.27 | 2.79 | 0.71 | 0.43 | 1.19 | 3.00 |
| DP9 | 0.39 | 2.76 | 0.83 | 0 | 0 | 0 |
| DP8 | 0.83 | 0 | 0 | 0.67 | 2.11 | 3.31 |
| DP7 | 1.85 | 3.28 | 1.23 | 1.27 | 2.93 | 3.65 |
| DP6 | 4.21 | 4.93 | 2.50 | 1.87 | 3.18 | 3.22 |
| DP5 | 6.46 | 7.55 | 4.92 | 4.08 | 4.48 | 4.25 |
| DP4 | 7.78 | 6.18 | 6.17 | 4.58 | 4.23 | 3.24 |
| DP3 | 3.63 | 3.00 | 2.53 | 4.22 | 2.91 | 3.00 |
| DP2 | 1.96 | 2.15 | 0.04 | 0.57 | 0.87 | 0.38 |
| DP1 | 18.75 | 0.91 | 5.34 | 2.53 | 1.50 | 2.18 |
| FRU | 37.61 | 39.89 | 47.92 | 36.99 | 36.66 | 35.68 |

Values are % of total sugar in syrups.
Bold headings are strain numbers.
DP = degree of polymerization (glucose units).
FRU = fructose
*= used 5:1 sucrose to maltose.

To get an estimate of the glycemic index values of the newly generated syrups, in vitro digestibility values of selected syrups were determined using the previously described rat intestinal powder assay (Table 6.1).

TABLE 6.1
T8 - % glucose release

| | |
|---|---|
| Maltose | 92.35 |
| 21297 | 14.90 |
| 1402 | 25.26 |
| 23185 | 19.83 |
| 23186 | 14.72 |
| 23188 | 17.40 |
| 23311 | 17.58 |

By directly correlating the percent glucose released in digestibility assays to glycemic index, it is expected that syrups generated by some of the other strains will have glycemic index (GI) values (for a given sucrose:acceptor ratio) similar to syrups generated by strain NRRL-B-21297.

### Example 7

### Various Food Products Made Using LGS

The following are specific examples of food products or food compositions that may be prepared, utilizing the LGS described herein.

A. Bars

1. Meal Replacement Bar

The control bar contained 18.7% soy protein isolate, 33.6% high fructose corn syrup (55 HFCS, 77% dry solid), 26.7% high maltose corn syrup (65% maltose, 80% dry solid), 5.4% maltodextrin, 1.4% novagel, 5% vitamin/mineral mix, 0.6% salt, 7.9% honey and 0.7% key lime flavor. The low glycemic bar contained 18.7% soy protein isolate, 64.5% LGS (made with 9:1 ratio of sucrose to maltose, at 80% dry solid), 1.2% water, 1.4% novagel, 5% vitamin/mineral mix, 0.6% salt, 7.9% honey, and 0.7% key lime flavor. The glycemic index of this low glycemic bar was calculated to be 49% lower than the control bar. The low glycemic bar was additionally tasted and found to have a taste similar to that of the control.

2. Other Bars

| | | | | Bar X w/LGS & | |
|---|---|---|---|---|---|
| Bar X: | | Bar X w/LGS: | | Maltodextrin: | |
| 18% | Soy protein | 18% | Soy protein | 18% | Soy Protein |
| 34% | HFCS 55 | 65% | LGS | 60% | LGS |
| 27% | Corn Syrup | 1.2% | water | 5% | Maltodextrin |
| 1.4% | Novagel | 1.4% | novagel | 1.4% | Novagel |
| 5% | vitamins mix | 5% | vitamins mix | 5% | vitamins mix |
| 0.6% | salt | 0.6% | salt | 0.6% | salt |
| 8% | honey | 8% | honey | 8% | honey |
| 0.7% | key lime flavor | 0.7% | key lime flavor | 0.7% | key lime flavor |

The ingredients provided above are mixed together and formed into portions.

3. Chocolate Mint Bar

| | Control | LGS |
|---|---|---|
| Ingredients | % | % |
| Prolisse 811 Soy Protein Isolate | 15.240 | 15.676 |
| Whey Protein Conc 80% | 7.120 | 7.324 |
| Hi form 12304 starch | 2.000 | 2.057 |
| Cocoa- Gerkens 10/12 Russett Plus | 4.960 | 5.102 |
| LGS lot 8 | 0.000 | 31.286 |
| 65% Satin Sweet Corn Syrup | 10.160 | 0.000 |
| 42 HFCS | 21.360 | 0.000 |
| Cargill Dry MD 01918 maltodextrin | 1.200 | 0.000 |
| Honey, clover | 6.080 | 6.254 |
| Baker's unsweetened chocolate | 2.080 | 2.139 |
| Canola Oil CV 65 | 4.080 | 4.197 |
| Glycerine PT #2001 | 2.040 | 2.098 |
| Water | 2.000 | 2.057 |
| Vitamin & Mineral Premix, FT032507 | 1.120 | 1.152 |
| N/A Peppermint flavor | 0.480 | 0.494 |
| N/A Vanilla flavor | 0.080 | 0.165 |
| Wilbur Sugar Free Chocolate Coating | 20.000 | 20.000 |
| Total | 100.000 | 100.000 |

Control and LGS chocolate mint bars were made according to the following procedure, using the ingredients as listed above.
a) The dry ingredients listed above (except for salt) were sifted and combined using a 6 quart Hobart mixer for 1 minute with a flat paddle.
b) LGS, honey, unsweetened chocolate, and oil in were heated in a microwave for 1 minute and then stirred until homogenous. Salt was added to the heated mixture and stirred.
c) The heated mixture was then added to the dry ingredients. These were combined in the mixer and mixed for 2 minutes on speed 2.
d) The water and flavors were then combined, and then added to the mixture in the Hobart mixer. The mixture was then mixed on speed 2 for about 3 minutes (until the dough formed).
e) The dough was then sheeted into ⅜″ thick bars and cut to the desired serving size.
f) The cut bars were then dipped into a sugar-free chocolate coating from Wilbur.
g) The bars were then refrigerated for 15 minutes to harden.
h) The bars were then sealed in an oxygen barrier bag or foil wrap and stored at room temperature.

4. Key Lime Bar

| | Control | LGS |
|---|---|---|
| Ingredients | % | % |
| Prolisse 811 Soy Protein Isolate | 13.840 | 13.840 |
| LGS lot 8 | 0.000 | 41.856 |
| Water | 0.000 | 2.000 |
| HFCS 55 | 22.480 | 0.000 |
| Satin Sweet 65% HM Corn Syrup | 17.600 | 0.000 |
| Maltodextrin (01920 CD Dry) | 3.776 | 0.000 |
| Honey | 6.280 | 6.280 |
| Novagel (Cellulose & Guar mix) | 1.000 | 1.000 |
| Salt | 0.400 | 0.400 |
| Vitamin & Mineral Premix | 3.464 | 3.464 |
| Key Lime Pie Flavor (#QL41931) | 0.496 | 0.496 |
| Graham Cracker Cookies bits | 10.664 | 10.664 |
| Wilbur Sugar Free Chocolate | 20.00 | 20.000 |
| Coating | | |
| Total | 100.000 | 100.000 |

Control and LGS key lime bars were made according to the following procedure, using the ingredients as listed above.
a) The dry ingredients listed above (except the cookie bits) were sifted and combined using a 6 quart Hobart mixer for 1 minute with a flat paddle.
b) The liquid ingredients were heated in a microwave for 1 minute and stirred until homogenous. Then, the flavors were added to the liquid mixture and stirred.
c) The heated mixture was then added to the dry ingredients. These were combined in the mixer at speed 2 until a dough formed.
d) The cookie bits were then added and the mixture mixed until the cookie bits were dispersed.
e) The dough was then sheeted into ⅜″ thick bars and cut to the desired serving size. The bars were then refrigerated to approx. 60° F.
f) The cooled bars were then dipped in sugar-free white chocolate coating from Wilbur.
g) The bars were then refrigerated for 15 minutes to harden.
h) The bars were then sealed in an oxygen barrier bag or foil wrap and stored at room temperature.

5. Cranberry Almond Bar

| | Control | LGS |
|---|---|---|
| Ingredient | % | % |
| ClearSweet 43% High | 30.19 | 0.00 |
| Maltose Corn Syrup | | |
| LGS, lot 8 | 0.00 | 30.19 |
| Sorbitol | 3.95 | 3.90 |
| Citric Acid | 0.08 | 0.08 |
| Canola Oil | 3.95 | 3.90 |
| Vanilla Flavor, | 0.49 | 0.49 |
| Cranberry Flavor | 0.20 | 0.20 |
| Lecithin | 0.16 | 0.16 |
| FONA Sweetness enhancer | 0.00 | 0.10 |
| Rice Crisps | 10.75 | 10.75 |
| Soy Crisps 80% | 20.80 | 20.80 |
| Raisins | 8.00 | 8.00 |
| Cranberry Halves | 10.70 | 10.70 |
| Whole Almond | 10.75 | 10.75 |
| Total | 100.00 | 100.00 |

Control and LGS cranberry almond bars were made according to the following procedure, using the ingredients as listed above.
a) The corn syrup was heated to 140° F., then sorbitol and citric acid were added and mixed, and the mixture heated to 180° F.
b) The flavors and oil were then added, and the mixture mixed well and cooked gently, until the Brix check was 87%.
c) In a separate bowl, the rice crisps, soy crisps, fruit, and almonds were combined and mixed.
d) 780 g syrup (from step b) was added to 1220 g dry ingredients (from step c) to make a 2000 g batch.
e) The mixture was transferred to a pan, rolled flat, and cooled in a refrigerator for 20 min.
f) The cooled mixture was cut to: L 4.0″, W 1.35″, and H 0.8″, and packaged in oxygen bather foil pouches.

6. Peanut Butter Bar

| | Control | LGS |
|---|---|---|
| Ingredients | % Formula | % Formula |
| LGS Lot 8 | 0.00 | 45.50 |
| HFCS | 34.00 | 0.00 |
| Maltodextrin 7.5 DE | 12.00 | 0.00 |
| Oat Bran | 22.00 | 22.00 |
| Milk Protein Isolate | 9.00 | 9.25 |
| Crisp Rice | 8.00 | 8.25 |
| Peanut Butter | 11.00 | 11.00 |
| Brown Rice Flour | 2.00 | 2.00 |
| Glycerine | 2.00 | 2.00 |
| Total | 100.00 | 100.00 |

Control and LGS peanut butter bars were made according to the following procedure, using the ingredients as listed above.
a) HFCS, maltodextrin, and glycerine were combined and heated in the microwave for 1 minute.
b) Peanut butter was added to the heated mixture and stirred until homogenous.
c) The dry ingredients listed above were sifted and combined using a 6 quart Hobart mixer for 1 minute with a flat paddle.
d) The heated mixture (from step b) was then added to the dry ingredients (from step c), and mixed in the mixer at speed 2 for 2-3 minutes until very well mixed.
d) The dough was then sheeted onto wax paper, about ½″ high.
e) The sheet was then placed into a refrigerator for 30 minutes to harden.
f) The sheet was then removed and cut to desired serving size.
g) The bars were then sealed in an oxygen bather foil wrap and stored at room temperature.

7. Satiety Bar

One possible benefit to LGS would be increased satiety over conventional sweeteners due to the slower rate of digestion for LGS. The formulas were balanced in terms of fructose percentage and the percentage of oligosaccharides. The main difference in the bars is that the oligosaccharides in the control come from maltodextrin. Therefore any difference in satiety should be attributed to the difference between LGS oligosaccharides and maltodextrin. The bars were not optimized for flavor or texture.

| | Control | LGS |
|---|---|---|
| Ingredients | % Formula | % Formula |
| LGS Lot 8 | 0.00 | 56.00 |
| HFCS | 29.00 | 0.00 |
| Chocolate Flavor | 0.50 | 0.50 |
| VanillaFlavor | 0.50 | 0.50 |
| Glycerine | 3.75 | 3.75 |
| Water | 2.70 | 0.00 |
| Whey Protein Isolate | 12.00 | 12.00 |
| Calcium Caseinate | 16.50 | 16.50 |
| Cocoa Powder | 3.50 | 3.50 |
| Rice Flour | 7.25 | 7.25 |
| Maltodextrin 18 DE | 24.30 | 0.00 |
| Total | 100.00 | 100.00 |

Control and LGS satiety bars were made according to the following procedure, using the ingredients as listed above.
a) HFCS, maltodextrin, and glycerine were combined and heated in the microwave for 1 minute.
b) The dry ingredients listed above were sifted and combined using a 6 quart Hobart mixer for 1 minute with a flat paddle.
d) The heated mixture was then added to the dry ingredients, and mixed in the mixer at speed 2 for 2 minutes.
d) The flavors were then combined and added to the mixture. The mixture was mixed at speed 2 for 2 minutes until a dough formed.
e) The dough was then sheeted and cut into bars, about 65 g each.
e) The bars were then placed into a refrigerator for 30 minutes to harden.
g) The bars were then sealed in an oxygen barrier foil wrap and stored at room temperature.

8. Nutrition and Glycemic Index Comparison

Samples of the bars made were tested for nutrition and glycemic index. The results appear below in Table 7.1

TABLE 7.1
Nutrition and Glycemic Index Comparison - Bars

| | | | | | Dietary | | Sugar | | | | |
|---|---|---|---|---|---|---|---|---|---|---|---|
| | Serving | | Fat | CHO | Fiber | Sugars | Alcohols | Protein | GI | Net | GL (per |
| Product | (g) | Calories | (g) | (g) | (g) | (g) | (g) | (g) | (Calc.) | CHO | serving) |
| Chocolate Mint | 50 | 180 | 7 | 25 | 3 | 15 | 2 | 10 | 53 | 20 | 11 |
| Bar (Control) | | | | | | | | | | | |
| Chocolate Mint | 50 | 180 | 7 | 24 | 4 | 9 | 2 | 11 | 35 | 18 | 6 |
| Bar (LGS) | | | | | | | | | | | |
| Cranberry | 50 | 190 | 5 | 28 | 1 | 14 | 2 | 10 | 76 | 25 | 19 |
| Almond Bar | | | | | | | | | | | |
| (Control) | | | | | | | | | | | |
| Cranberry | 50 | 190 | 5 | 28 | 2 | 13 | 2 | 10 | 62 | 24 | 15 |
| Almond Bar | | | | | | | | | | | |
| (LGS) | | | | | | | | | | | |
| Key Lime Bar | | | | | | | | | | | |
| (Control) | | | | | | | | | | | |
| Key Lime Bar | | | | | | | | | | | |
| (LGS) | | | | | | | | | | | |
| Peanut Butter | 65 | 220 | 4 | 41 | 3 | 17 | 0 | 10 | 91 | 38 | 35 |
| Bar (Control) | | | | | | | | | | | |
| Peanut Butter | 65 | 230 | 4 | 42 | 3 | 13 | 0 | 10 | 58 | 39 | 23 |
| Bar (LGS) | | | | | | | | | | | |

B. Beverages

1. Meal Replacement Beverage I

The control beverage contains 54.9% skim milk, 10% cold water, 0.4% cellulose, 0.01% carageenan, 1% soy protein concentrate, 1% maltodextrin, 0.49% cocoa powder, 0.18% trisodium citrate, 0.06% salt, 6% high fructose corn syrup (42HFCS, 71% dry solid), 2% high fructose corn syrup (55HFCS, 77% dry solid), 2% high maltose corn syrup (65% maltose, 80% dry solid), 1% corn syrup solids, 0.1% canola oil, 0.1% cinnamon, 0.1% chocolate flavor, 0.1% vanilla, 0.05% cooked milk flavor. The low glycemic beverage has 12% LGS (made with 9:1 ratio of sucrose and maltose, at 80% dry solid), 54.9% skim milk, 10% cold water, 0.4% cellulose, 0.01% carageenan, 1% soy protein concentrate, 0.49% cocoa powder, 0.18% trisodium citrate, 0.06% salt, 0.1% canola oil, 0.1% cinnamon, 0.1% chocolate flavor, 0.1% vanilla, 0.05% cooked milk flavor. The low glycemic beverage has a 36% reduction in calculated glycemic index as compared to control beverage.

2. Still Beverage (Sports Beverage Type)

The beverage control was prepared by dissolving and/or mixing 85.30 g/L of Cargill IsoClear High Fructose Corn Syrup 42, 2.0 g/L of Citric Acid, 0.35 g/L of Potassium. Citrate, 0.58 g/L of Sodium Chloride, 0.05 g/L of DiPotassium Phosphate, 0.45 ml/L of Red Cabbage Extract (Warner Jankinson, WJ03813), 1.50 ml/L of Natural Punch Flavor and water to bring to the volume. The beverage then pasteurized at 190-195° F. for 2 minutes and hot-filled to glass bottles before the containers are sealed. The low glycemic beverage was made the same as control except Cargill IsoClear HFCS-42 was replaced with 76.10 g/L of Cargill LLGS (made with 9:1 ratio of sucrose and maltose, at 80% dry solid). Everything else remained the same. The calculated glycemic index of the low glycemic beverage is 45% lower than the control.

3. Carbonated Beverage

The control beverage contains 11.2° Brix of High Fructose Corn Syrup (HFCS) 42, 0.66 g of 75% phosphoric acid per liter of beverage, and cola flavor The beverage is then carbonated to 3.5 volume carbonation and filled into a container. Up to 200 ppm of caffeine can optionally be added to both beverages.

The low glycemic cola beverage with approximately the equivalent sweetness level contains 5.6° Brix of LGS and 56 G/L of crystalline fructose. The beverage is then carbonated to 3.5 volume carbonation and filled into a container. Up to 200 ppm of caffeine can optionally be added to both beverages. The resulting LGS beverage has a 57% reduction in calculated glycemic index as compared to the control.

4. Non-carbonated Beverage

The control beverage contains 10% white grape juice as concentrate and 10° Brix of high fructose corn syrup 42, 2.0 G/L of citric acid anhydrous, 1.0 G/L of red cabbage extract, natural kiwi-strawberry flavor. The beverage is then pasteurized at 190-195° F. for 2 minutes and bottled and sealed.

The low glycemic beverages are made by replacing 10° Brix of high fructose corn syrup with 5.0° Brix of low glycemic syrup and 5.0 ° Brix of Special Fx™ 90% fructose (Cargill, Inc.). The rest of the ingredients and process remained the same.

5. Meal Replacement Beverage II

Flavored meal replacement beverages, including LGS and comparison control beverages were created. These beverages were made by mixing the ingredients listed below for each sample under high shear until homogeneous. The homogeneous samples were then UHT processed (preheated to 185° F., homogenized at 3000 psi, heated to 285° F. for 3 seconds.) The samples were then cooled instantly to 60° F. The samples were then filled into sterile bottles under clean hood and stored refrigerated. Taste testing found that the LGS samples were more rounded in flavor and sweetness. For both chocolate and vanilla versions, the LGS samples were preferred over the control samples. The LGS versions were also slightly darker, but still considered acceptable in appearance.

| | Chocolate | Chocolate | Vanilla | Vanilla |
|---|---|---|---|---|
| | Control | LGS | Control | LGS |
| Ingredient | % | % | % | % |
| Maltidex H 16322 (71.6 Bx) | 5.500 | 0.000 | 5.500 | 0.000 |
| Sucrose, granule | 4.250 | 0.000 | 4.250 | 0.000 |
| Maltodextrin (10DE) | 5.000 | 0.000 | 5.000 | 0.000 |
| LGS | 0.000 | 12.000 | 0.000 | 12.000 |
| H.O. 75 canola oil | 3.000 | 3.000 | 3.000 | 3.000 |
| Soy lecithin | 0.045 | 0.045 | 0.045 | 0.045 |
| Calcium caseinate | 2.420 | 2.420 | 2.420 | 2.420 |
| Sodium caseinate | 1.250 | 1.250 | 1.250 | 1.250 |
| Soy protein isolate | 0.900 | 0.900 | 0.900 | 0.900 |
| Gerkins Cocoa (Russet Plus) | 0.250 | 0.250 | 0.000 | 0.000 |
| Gerkins Cocoa (Magenta) | 0.250 | 0.250 | 0.000 | 0.000 |
| Gerkins Cocoa (Sienna) | 0.500 | 0.500 | 0.000 | 0.000 |
| Inulin | 1.250 | 1.250 | 1.250 | 1.250 |
| Erythritol | 0.000 | 2.000 | 0.000 | 2.000 |
| Sucralose (25% solution) | 0.010 | 0.010 | 0.010 | 0.010 |
| Acesulfame K | 0.005 | 0.005 | 0.005 | 0.005 |
| Quest Sugar type QL40910 | 0.050 | 0.050 | 0.050 | 0.050 |
| Trisodium Citrate | 0.070 | 0.070 | 0.070 | 0.070 |
| Salt | 0.100 | 0.100 | 0.100 | 0.100 |
| Gellan Gum | 0.140 | 0.140 | 0.140 | 0.140 |
| Vitamin premix | 0.990 | 0.990 | 0.990 | 0.990 |
| Wild Creamy Choc FAFN414 | 0.300 | 0.300 | 0.000 | 0.000 |
| Wild Choc Chip N412 | 0.300 | 0.300 | 0.000 | 0.000 |
| Wild Dark Choc N417 | 0.030 | 0.030 | 0.000 | 0.000 |
| DM Vanilla Ice Cream 20397 | 0.000 | 0.000 | 0.380 | 0.380 |
| Givaudan French Vanilla | 0.000 | 0.000 | 0.330 | 0.330 |
| 559415 | | | | |
| Firmenlch Malt 597993T | 0.000 | 0.000 | 0.030 | 0.030 |
| Water | 73.400 | 74.150 | 74.290 | 75.040 |
| TOTAL | 100.0 | 100.0 | 100.0 | 100.0 |

6. Energy Beverage

Energy beverages including a control, LGS, and LGS Special Fx blends were made. The ingredients listed below for each version were blended together and then carbonated to 3.2.

| | Control | LGS | LGS/SpFx |
|---|---|---|---|
| Ingredient | % | % | % |
| Sucrose-crystalline | 8.200 | — | — |
| Glucose Powder | 2.000 | — | — |
| LGS-Lot 8 | — | 12.740 | 5.100 |
| Sp Fx-lot21-77Bx | — | — | 7.940 |
| Vita B12 (0.1% mix) | 0.020 | 0.020 | 0.020 |
| Niacin | 0.008 | 0.008 | 0.008 |
| Vita B6 | 0.002 | 0.002 | 0.002 |
| Pantothenic Acid | 0.002 | 0.002 | 0.002 |
| Caffeine | 0.030 | 0.030 | 0.030 |
| Taurine | 0.400 | 0.400 | 0.400 |
| Glucuronolactone | 0.230 | 0.230 | 0.230 |
| Inositol | 0.010 | 0.010 | 0.010 |
| Trisodium Citrate | 0.300 | 0.300 | 0.300 |
| Citric Acid | 0.650 | 0.650 | 0.650 |
| Sodium Benzoate | 0.010 | 0.010 | 0.010 |
| Sucralose(25% sol'n) | — | 0.007 | — |
| Aspartame | — | 0.005 | — |
| Wild Fantasy Fruit Flv #FAFR046 | 0.030 | 0.030 | 0.030 |
| DM tropical citrus Flv #24383 | 0.016 | 0.016 | 0.016 |
| Yellow #5- 1% sol'n | 0.020 | 0.020 | 0.020 |
| Yellow #6- 1% sol'n | 0.010 | 0.010 | 0.010 |
| Cloud-Quest | 0.010 | — | — |
| Water (Q.S. with water to make | 88.052 | 85.510 | 85.220 |
| 100%) | | | |
| | 100.00 | 100.00 | 100.00 |

In taste tests it was found that LGS version had a slight flavor masking with a slight perceived increase in sweetness compared to the control. The LGS Special Fx was found to have the same sweetness as the control, with a well-rounded mouthfeel, but had a slight bitter aftertaste.

7. Mid Calorie Lemon-Lime Soda Beverage

Mid-calorie beverages with lemon-lime flavor Energy beverages including control and LGS versions were made. The ingredients listed below for each version were blended together. Then, carbonated bottle water was added to 1+5 syrup, forming the beverage.

| | Control | LGS |
|---|---|---|
| Ingredients | % | % |
| HFCS 42 | 7.315 | 0.000 |
| LGS - lot 8 | 0.000 | 6.490 |
| Citric Acid | 0.115 | 0.115 |
| Trisodium citrate | 0.020 | 0.020 |
| Giv. LL 509882 | 0.200 | 0.200 |
| Sucralose (25% soln) | 0.015 | 0.019 |
| Aspartame | 0.012 | 0.015 |
| Quest QL40910 | 0.000 | 0.100 |
| Water | 92.323 | 93.041 |
| Total | 100.000 | 100.000 |

The initial LGS version did not include the Quest ingredient and had a bland finish. With the addition of Quest to the LGS version, the sweetness profile was rounded out and had a flavor and sweetness very close to the control. Both the control and LGS versions had a Brix level at 5.1 and pH 2.9.

8. Nutrition and Glycemic Index Comparison

Samples of the beverages made were tested for nutrition and glycemic index. The results appear below in Table 7.2.

TABLE 7.2
Nutrition and Glycemic Index Comparison - Beverages

| | | | | | Dietary | | Sugar | | | | |
|---|---|---|---|---|---|---|---|---|---|---|---|
| | Serving | | Fat | CHO | Fiber | Sugars | Alcohols | Protein | GI | Net | GL (per |
| Product | (g) | Calories | (g) | (g) | (g) | (g) | (g) | (g) | (Calc.) | CHO | serving) |
| Chocolate | 256 | 260 | 8 | 39 | 3 | 12 | 10 | 11 | 41 | 26 | 11 |
| MRB | | | | | | | | | | | |
| (Control) | | | | | | | | | | | |
| Chocolate | 256 | 240 | 8 | 36 | 4 | 13 | 5 | 11 | 36 | 27 | 10 |
| MRB (LGS) | | | | | | | | | | | |
| Vanilla MRB | 256 | 250 | 8 | 38 | 3 | 12 | 10 | 11 | 41 | 25 | 10 |
| Vanilla MRB | 256 | 230 | 8 | 35 | 3 | 13 | 5 | 11 | 36 | 27 | 10 |
| Energy | 256 | 110 | 0 | 29 | 0 | 27 | 0 | 0 | 73 | 29 | 21 |
| Drink(Control) | | | | | | | | | | | |
| Energy Drink | 256 | 110 | 0 | 28 | 0 | 13 | 0 | 0 | 42 | 28 | 12 |
| (LGS) | | | | | | | | | | | |
| Energy Drink | 256 | 110 | 0 | 28 | 0 | 21 | 0 | 0 | 36 | 28 | 10 |
| (LGS/SpFx) | | | | | | | | | | | |
| Mid-Calorie | 256 | 50 | 0 | 14 | 0 | 13 | 0 | 0 | 91 | 14 | 13 |
| Lemon Lime | | | | | | | | | | | |
| Soda | | | | | | | | | | | |
| (Control) | | | | | | | | | | | |
| Mid-Calorie | 256 | 50 | 0 | 14 | 0 | 7 | 0 | 0 | 44 | 14 | 6 |
| Lemon Lime | | | | | | | | | | | |
| Soda (LGS) | | | | | | | | | | | |

C. Fruit Products

1. Raspberry Jam

The control jam had 39.1% fruit, 32.1% corn syrup (43DE, 80% dry solid), 13% sugar, 0.5% pectin, 2.6% water, 11.7% high fructose corn syrup (42HFCS, 71% dry solid), 0.2% potassium sorbate, 0.2% sodium benzoate, 0.6% citric acid solution (50%). The low glycemic jam contained 28.1% fruit, 57.9% LGS (made with 9:1 ratio of sucrose and maltose, at 80% dry solid), 0.5% pectin, 2.5% water, 0.2% potassium sorbate, 0.2% sodium benzoate, 0.6% citric acid solution. The low glycemic jam has a 60% reduction in calculated glycemic index as compared to the control jam.

2. Strawberry Fruit Prep

| | Control | LGS |
|---|---|---|
| Ingredients | % | % |
| IQF Strawberries | 42.00% | 42.00% |
| Sucrose | 30.00% | 0.00% |
| LGS | 0.00% | 37.04% |
| Water | 24.90% | 17.76% |
| Starch (75720) | 3.00% | 3.10% |
| Potassium Sorbate | 0.10% | 0.10% |
| TOTAL | 100.00% | 100.00% |

Control and LGS strawberry fruit preparations were made according to the following procedure, using the ingredients as listed above.
a) The strawberries were pureed using a food processor.
b) The sucrose or LGS, and starch were dry blended together.
c) The puree, water, and dry ingredients were added to a double boiler and mixed.
d) The mixture was heated to boiling (185° F.-190° F.) and held at boiling for 5 minutes with constant agitation.
e) The mixture was cooked to 50-55 Brix.
f) The mixture was removed from heat and poured into sterile one cup jars, sealed with lids, and then refrigerated.

3. Strawberry Jam

| | Control | LGS |
|---|---|---|
| Ingredient | % Formula | % Formula |
| Water | 0.00 | 4.04 |
| IsoClear HFCS 42 | 38.30 | 0.00 |
| Clearsweet 43/43 Corn Syrup | 22.50 | 0.00 |
| LGS | 0.00 | 56.36 |
| IQF Strawberries | 38.55 | 38.55 |
| HM Pectin- CP Kelco B Rapid Set | 0.40 | 0.55 |
| Citric acid | 0.25 | 0.25 |
| Frutarom Natl Strawberry flvr | 0.00 | 0.20 |
| 915741 | | |
| Sucralose 25% solution | 0.00 | 0.05 |
| Total | 100.00 | 100.00 |

Control and LGS strawberry jams were made according to the following procedure, using the ingredients as listed above.
a) 140 Grams of water was heated to 170° F., and the pectin was added and stirred until dissolved.
b) The strawberries were pureed using a food processor.
c) All ingredients except the pectin and citric acid were added to a double boiler and mixed.
d) The mixture was heated to and maintained at a rolling boil until 65° Brix.
e) The pectin solution was added and the mixture boiled for 1 minute.
f) The mixture was removed from the heat, and citric acid was added to adjust the mixture to pH 3.0-3.2.
g) Foam was skimmed off the top of the mixture.
h) The mixture was poured into sterile jars with ¼″ headspace, wiped, and sealed with lids.
i) The jars were placed in a rack, placed in a canner, and the jars covered with at least 1 inch of water.
j) The canner was covered with a lid, the water brought to boiling, and the jars boiled for 5 minutes.
k) The jars were allowed to cool for 24 hours, and the seals checked. Any jars having a loose seal were refrigerated, while the sealed jars were stored at room temperature.

4. Nutrition and Glycemic Index Comparison

Samples of the fruit products made were tested for nutrition and glycemic index. The results appear below in Table 7.3.

TABLE 7.3
Nutrition and Glycemic Index Comparison - Fruit Products

| | | | | | Dietary | | Sugar | | | | |
|---|---|---|---|---|---|---|---|---|---|---|---|
| | Serving | | Fat | CHO | Fiber | Sugars | Alcohols | Protein | GI | Net | GL (per |
| Product | (g) | Calories | (g) | (g) | (g) | (g) | (g) | (g) | (Calculated) | CHO | serving) |
| Strawberry | 20 | 50 | 0 | 13 | 0 | 9 | 0 | 0 | 51 | 13 | 7 |
| Fruit Prep | | | | | | | | | | | |
| (Control) | | | | | | | | | | | |
| Strawberry | 20 | 50 | 0 | 13 | 1 | 7 | 0 | 0 | 27 | 12 | 3 |
| Fruit Prep | | | | | | | | | | | |
| (LGS) | | | | | | | | | | | |
| Strawberry | 20 | 40 | 0 | 9 | 0 | 8 | 0 | 0 | 70 | 9 | 6 |
| Jam (Control) | | | | | | | | | | | |
| Strawberry | 20 | 40 | 0 | 10 | 0 | 5 | 1 | 0 | 32 | 9 | 3 |
| Jam (LGS) | | | | | | | | | | | |

D. Yogurt

1. Low Fat Yogurt

The control yogurt has 91% milk (2%), 5% sugar, 2% starch, 1% whey protein concentrate, and 1% milk solids (non fat). The low glycemic yogurt contains 89.5% milk (2%), 8.5% LGS (made with 9:1 ratio of sucrose and maltose, at 80% dry solid), 1% whey protein concentrate, and 1% milk solids (non fat). The low glycemic yogurt has a 37% reduction in calculated glycemic index as compared to the control.

2. Vanilla Yogurt

| Ingredient | Control | LGS |
|---|---|---|
| 2% milk | 50.0 | 50.0 |
| Skim milk | 34.4 | 32.7 |
| Sucrose | 7.5 | 0.0 |
| Polar Tex 06746 | 2.5 | 2.5 |
| Nonfat dry milk low heat | 2.0 | 2.0 |
| HFCS 42 | 2.0 | 0.0 |
| LGS | 0.0 | 11.1 |
| Sucralose (25% soln) | 0.0 | 0.0 |
| Aspartame | 0.0 | 0.0 |
| WPC 34% | 1.0 | 1.0 |
| 250 bloom hide gelatine | 0.3 | 0.3 |
| Robertet French Vanilla | 0.3 | 0.3 |
| Total | 100.0 | 100.0 |

Control and LGS vanilla yogurts were made according to the following procedure, using the ingredients as listed above.
a) All of the ingredients (except flavors) were mixed together by hand until well mixed.
b) The mixture was heated in a microwave until the mixture reached 160° F.-170° F.
c) The mixture was then placed in a water bath until it cooled to 41° C.
d) 1.0 grams of Rhodia ABY-SNC culture was mixed with 50 g of cold milk, and allowed to hydrate for 20 minutes.
e) 4 g of hydrated culture was added per 1 L of mixture.
f) The mixture with culture was incubated at 41° C. (using the water bath) for 6 hours, and the pH measured.
g) The flavors were well mixed into the mixture, and then the mixture stored in a refrigerator.

Both the control and LGS version were found to have similar sweetness level via taste-testing. The measured pH of both control and LGS was pH 4.5.

3. Strawberry Yogurt

| Ingredient | Control | LGS |
|---|---|---|
| 2% milk | 40.000 | 40.000 |
| Skim milk | 29.240 | 28.170 |
| Sucrose | 10.800 | 0.000 |
| Polar Tex 06746 | 2.000 | 2.000 |
| Nonfat dry milk low heat | 1.600 | 1.600 |
| HFCS 42 | 1.280 | 0.000 |
| LGS | 0.000 | 14.540 |
| Sucralose (25% soln) | 0.000 | 0.011 |
| Aspartame | 0.000 | 0.007 |
| WPC 34% | 0.800 | 0.800 |
| 250 bloom hide gelatine | 0.280 | 0.280 |
| Pureed frozen strawberries | 8.400 | 8.400 |
| Water | 5.000 | 3.570 |
| Starch | 0.600 | 0.620 |
| Total | 100.000 | 100.000 |

Control and LGS strawberry yogurts were made according to the following procedure, using the ingredients as listed above.
a) All of the ingredients were mixed together by hand until well mixed.
b) The mixture was heated in a microwave until the mixture reached 160° F.-170° F.
c) The mixture was then placed in a water bath until it cooled to 41° C.
d) 1.0 grams of Rhodia ABY-SNC culture was mixed with 50 g of cold milk, and allowed to hydrate for 20 minutes.
e) 4 g of hydrated culture was added per 1L of mixture.
f) The mixture with culture was incubated at 41° C. (using the water bath) for 6 hours.
g) Then, the yogurt prepared as above was mixed with fruit prep from C.2 (above), with control fruit prep mixed into control yogurt, and LGS fruit prep mixed with LGS yogurt, at a ratio of 80 to 20.

The control version was found to be slightly sweeter than the LGS version. The control version had a fresh fruit flavor while the LGS version was more viscous and seemed starchy, and had a cooked fruit flavor. The color of the LGS version was more grey and dull in appearance than the control version.

4. Nutrition and Glycemic Index Comparison

Samples of the yogurts made were tested for nutrition and glycemic index. The results appear below in Table 7.4.

TABLE 7.4
Nutrition and Glycemic Index Comparison - Yogurts

| | | | | | Dietary | | Sugar | | | | |
|---|---|---|---|---|---|---|---|---|---|---|---|
| | Serving | | Fat | CHO | Fiber | Sugars | Alcohols | Protein | GI | Net | GL (per |
| Product | (g) | Calories | (g) | (g) | (g) | (g) | (g) | (g) | (Calculated) | CHO | serving) |
| Strawberry | 170 | 170 | 1.5 | 33 | 0 | 29 | 0 | 6 | | 33 | 0 |
| Yogurt | | | | | | | | | | | |
| (Control) | | | | | | | | | | | |
| Strawberry | 170 | 170 | 1.5 | 33 | 1 | 19 | 0 | 6 | | 32 | 0 |
| Yogurt (LGS) | | | | | | | | | | | |
| Vanilla | 225 | 210 | 2.5 | 38 | 0 | 33 | 0 | 9 | | 38 | 0 |
| Yogurt | | | | | | | | | | | |
| (Control) | | | | | | | | | | | |
| Vanilla | 225 | 210 | 2.5 | 38 | 0 | 23 | 0 | 9 | | 38 | 0 |
| Yogurt (LGS) | | | | | | | | | | | |

E. Ice Cream

1. Ice Cream I

The control ice cream contains 12% fat, 10% milk solid, 13% sucrose, 5% corn syrup (36DE, 80% dry solid), and 0.35% stabilizer. The low glycemic ice cream has 12% fat, 10% milk solid, 5% sucrose, 13% LGS (made with 9:1 ratio of sucrose and maltose, at 80% dry solid), and 0.35% stabilizer. The low glycemic ice cream has a 35% reduction in calculated glycemic index as compared to the control.

2. Ice Cream II

| | | | | | | | Freezing Point (F.) | | |
|---|---|---|---|---|---|---|---|---|---|
| | Amount (as/is | | | | | | Glycemic | FPD due | PFD due |
| Formula (%) | basis) | Fat (%) | MSNF (%) | Sugar (%) | T.S. (%) | Sweetness | Index | to Sugars | to Salts |

a. Example of an ice cream control formula

| | | | | | | | | | |
|---|---|---|---|---|---|---|---|---|---|
| Cream-40.0% Fat | 30.00 | 12.00 | 1.61 | — | 13.61 | — | — | — | — |
| Sucrose | 13.00 | — | — | 13.00 | 13.00 | 13.00 | 8.84 | 13.00 | — |
| Clearsweet 36/43 | 6.22 | — | — | 5.00 | 5.00 | 1.75 | 6.22 | 3.60 | — |
| Non fat dry milk powder | 10.31 | 0.09 | 10.00 | 5.21 | 10.00 | — | 2.39 | 5.40 | 23.70 |
| Stabilizer/Emulsifier | 0.40 | — | — | — | 0.40 | — | — | — | — |
| LGS | — | — | — | — | — | — | — | — | — |
| Total | 59.93 | 12.09 | 11.61 | 23.21 | 42.01 | 14.75 | 17.45 | 22.00 | 23.70 |
| | | | | | | | 75.21 | 37.93 | 0.41 |

b. Example of an ice cream with low glycemic value using LGS

| | | | | | | | | | |
|---|---|---|---|---|---|---|---|---|---|
| Cream-40.0% tat | 30.00 | 12.00 | 1.61 | — | 13.61 | — | — | — | — |
| Sucrose | — | — | — | — | — | — | — | — | — |
| Clearsweet 36/43 | — | — | — | — | — | — | — | — | — |
| Non fat dry milk powder | 10.31 | 0.09 | 10.00 | 5.21 | 10.00 | — | 2.39 | 5.40 | 23.70 |
| Stabilizer/Emulsifier | 0.40 | — | — | — | 0.40 | — | — | — | — |
| LGS | 25.00 | — | — | 20.00 | 20.00 | 11.00 | 9.25 | 16.80 | — |
| Total | 65.71 | 12.09 | 11.61 | 25.21 | 44.01 | 11.00 | 11.64 | 22.20 | 23.70 |

c. Example of an ice cream with low glycemic value using LGS & a polyol (erythritol)*

| | | | | | | | | | |
|---|---|---|---|---|---|---|---|---|---|
| Cream-40.0% fat | 30.00 | 12.00 | 1.61 | — | 13.61 | — | — | — | — |
| Sucrose | — | — | — | — | — | — | — | — | — |
| Clearsweet 36/43 | — | — | — | — | — | — | — | — | — |
| Non fat dry milk powder | 10.31 | 0.09 | 10.00 | 5.21 | 10.00 | — | 2.39 | 5.40 | 23.70 |
| Stabilizer/Emulsifier | 0.40 | — | — | — | 0.40 | — | — | — | — |
| LGS | 16.25 | — | — | 13.00 | 13.00 | 7.15 | 6.01 | 10.92 | — |
| Erythritol | 5.00 | — | — | — | 5.00 | 3.00 | 1.85 | 14.00 | — |
| Total | 61.96 | 12.09 | 11.61 | 18.21 | 42.01 | 10.15 | 10.26 | 30.32 | 23.70 |

d. Example of an ice cream with low glycemic value using LGS & a polyol (erythritol) & and intense sweetener (sucralose)*

| | | | | | | | | | |
|---|---|---|---|---|---|---|---|---|---|
| Cream-40.0% fat | 30.00 | 12.00 | 1.61 | — | 13.61 | — | — | — | — |
| Sucrose | — | — | — | — | — | — | — | — | — |
| Clearsweet 36/43 | — | — | — | — | — | — | — | — | — |
| Non fat dry milk powder | 10.31 | 0.09 | 10.00 | 5.21 | 10.00 | — | 2.39 | 5.40 | 23.70 |
| Stabilizer/Emulsifier | 0.40 | — | — | — | 0.40 | — | — | — | — |
| LGS | 16.25 | — | — | 13.00 | 13.00 | 7.15 | 6.01 | 10.92 | — |
| Erythritol | 5.00 | — | — | — | 5.00 | 3.00 | 1.65 | 14.00 | — |
| Sucralose | 0.02 | — | — | — | — | 5.00 | — | — | — |
| Total | 61.96 | 12.09 | 11.61 | 18.21 | 42.01 | 15.15 | 10.26 | 30.32 | 23.70 |

T.S. = total solids,
Amount (as/is basis) = weight of ingreadient added,
MSNF = milk solids nonfat,
FPD = freezing point depression.

3. Unflavored Ice Creams

| | | Control | | | Trial |
|---|---|---|---|---|---|
| | Control | #2 | | Trial | #3 |
| | #1 | No | Trial | #2 | LGS + |
| | Full | Sugar | #1 | LGS + | Maltitol + |
| | Sugar | added | LGS | Maltitol | Erythritol |
| Ingredient | % As is | % As is | % As is | % As is | % As is |
| Cream- 40% Fat | 25.00 | 25.00 | 25.00 | 25.00 | 25.00 |
| Sucrose | 13.00 | 0.00 | 0.00 | 0.00 | 0.00 |
| 36 DE Syrup | 6.22 | 0.00 | 0.00 | 0.00 | 0.00 |
| NFDM | 10.00 | 10.00 | 10.00 | 10.00 | 10.00 |
| Stabilizer | 0.55 | 0.55 | 0.55 | 0.55 | 0.55 |
| LGS | 0.00 | 0.00 | 22.22 | 16.67 | 16.67 |
| Maltitol | 0.00 | 13.13 | 0.00 | 11.25 | 6.88 |
| Erythritol | 0.00 | 0.00 | 0.00 | 0.00 | 3.54 |
| Sucralose | 0.00 | 0.02 | 0.02 | 0.02 | 0.02 |
| Isomalt | 0.00 | 8.06 | 0.00 | 0.00 | 0.00 |
| Water | 45.23 | 43.24 | 42.21 | 36.51 | 37.34 |
| TOTAL | 100.00 | 100.00 | 100.00 | 100.00 | 100.00 |

A number of control, LCG, and LGS+unflavored ice creams were produced using the ingredients listed above. All ice creams which included LGS also included a small amount of sucralose. The 40% fat cream used was obtained from Dairy America (Fresno, Calif.). The stabilizer utilized in all samples was Kontrol (Danisco). No flavor was used. For each sample, a 70.0-pound batch was produced. The ice cream was frozen using a Technogel freezer, with temperatures ranging from 20-24° F.

Two control samples were produced in this study. The first control sample was a full-sugar ice cream; thus 36DE corn syrup, Clearsweet 36/43 (Cargill), and granulated sucrose were incorporated. This is a representative sweetening system found in the majority of commercially available ice cream in the USA and Canada. The other control was indicative of a commercially available no-sugar-added system, in which maltitol and isomalt were used. Three experimental samples were generated, in which all contained LGS and sucralose. In addition to LGS and sucralose, two of the experimental samples contained sugar alcohols. The composition of the control and samples one through five are outlined above.

A summary of properties of the ice cream components is as follows:

| | | | | |
|---|---|---|---|---|
| | Fat | MSNF | Sugar | Total Solids |
| Ingredient | (%) | (%) | (%) | (%) |

Control One- Full Sugar: 36DE Corn Syrup + Sucrose

| | | | | |
|---|---|---|---|---|
| Cream | 10.0 | 1.34 | — | 11.3 |
| Sucrose | — | — | 13.0 | 13.0 |
| 36 DE syrup | — | — | 5.00 | 5.00 |
| NFDM Powder | 0.09 | 9.70 | 5.05 | 9.70 |
| Stabilizer | — | — | — | 0.50 |
| Total | 10.1 | 11.0 | 23.1 | 39.5 |

Control Two- No Sugar Added: Maltitol + Isomalt + Sucralose

| | | | | |
|---|---|---|---|---|
| Cream | 10.0 | 1.34 | — | 11.3 |
| Maltitol | — | — | 10.5 | 10.5 |
| Isomalt | — | — | 7.50 | 7.50 |
| Sucralose | — | — | — | 2.11 g/70# batch |
| NFDM | 0.09 | 9.70 | 5.05 | 9.70 |
| Stabilizer | — | — | — | 0.50 |
| Total | 10.1 | 11.0 | 23.1 | 39.5 |

Trial One- LGS

| | | | | |
|---|---|---|---|---|
| Cream | 10.0 | 1.34 | — | 11.3 |
| LGS | — | — | 18.0 | 18.0 |
| Sucralose | — | — | — | 1.54 g/70.0# batch |
| NFDM | 0.09 | 9.70 | 5.05 | 9.70 |
| Stabilizer | — | — | — | 0.50 |
| Total | 10.1 | 11.0 | 23.1 | 39.5 |

Trial Two- LGS + Maltitol

| | | | | |
|---|---|---|---|---|
| Cream | 10.0 | 1.34 | — | 11.3 |
| LGS | — | — | 9.00 | 9.00 |
| Maltitol | — | — | 9.00 | 9.00 |
| Sucralose | — | — | — | 1.58 g/70# batch |
| NFDM | 0.09 | 9.70 | 5.05 | 9.70 |
| Stabilizer | — | — | — | 0.50 |
| Total | 10.1 | 11.0 | 23.1 | 39.5 |

Trial Three- LGS + Maltitol + Erythritol

| | | | | |
|---|---|---|---|---|
| Cream | 10.0 | 1.34 | — | 11.3 |
| LGS | — | — | 9.00 | 9.00 |
| Maltitol | — | — | 5.50 | 5.50 |
| Erythritol | — | — | 3.52 | 3.52 |
| Sucralose | — | — | — | 1.92 g/70# batch |
| NFDM | 0.09 | 9.70 | 5.05 | 9.70 |
| Stabilizer | — | — | — | 0.50 |
| Total | 10.1 | 11.0 | 23.1 | 39.5 |

Sample preparation and ingredient addition were conducted in the exactly the same manner for every trial. Fat, syrup/sugar, and water were blended together, followed by NFDM and stabilizer, and then heated to 185° F. Mix total for each sample was 70.0 pounds. The capacity of the freezer is approximately one 70.0-pound batch per hour. The mix was then passed through a dual-stage homogenizer, and cooled via passage through a tubular heat exchanger at 75° F. The cooled mix was then placed in a bucket, sealed and stored at 37° F. overnight. The mix was frozen and extruded using a Technogel-Freezer 100 freezer. Overrun set point was 80% and exit temperature was approximately 20-24° F. Once dispensed, the ice cream was stored frozen until shipped.
a. Glycemic Index. A significant reduction in glycemic index was achieved in all samples when compared to the control. To calculate the GI, each sugar or sugar-containing ingredient is assigned a specific value. This value is multiplied by the amount of ingredient used in the mix on an as-is basis. The sum of GI values for all ingredients are added, and then divided by the sum of total sugars in the mix. For example, the calculated GI for the control is 70.1 using the formula:

$$\frac{[ \begin{matrix}( 13.0 \% sucrose * 68 ) + \\ ( 5.00 \% 36 DE * 100 ) + ( 5.05 \% NFDM * 46 )\end{matrix} ]}{[ ( 13.0 \% sucrose ) + ( 5.0 \% 36 DE ) + ( 5.05 \% NFDM )}$$

b. Freezing Point Depression. The freezing point depression due to sugars varied widely among the different samples. This is inherently due to the molecular weight of the various ingredients used in each trial. As with GI, each ingredient possesses a unique freezing point depression factor. The freezing point depression factor is simply obtained by dividing the molecular weight of the substance by that of sucrose (342). Low molecular weight substances yield a high freezing point depression, whereas large polymers have a very low associated value. A table of these values is listed for each ingredient. To calculate the freezing point depression for a particular ice cream mix, the percentage of each ingredient on an as-is basis is multiplied by its freezing point depression value. The sum of all freezing point values yields the freezing point depression for the ice cream mix. Freezing point depression due to salts was ignored in this study due to negligible impact. A summary of the freezing point depression for each sample is listed below.

The impact of freezing point depression is a critical factor to all ice cream manufacturers when designing a formula. A value that is too high will result in a product that is hard and difficult to scoop. An ice cream possessing a low value will be soft, thus resulting with a decreased shelf life.

Values of Individual Sweeteners

| | Glycemic | Freezing |
|---|---|---|
| Ingredient | Value | Point Factor |
| Sucrose | 68 | 1.00 |
| 36 DE Corn Syrup | 100 | 0.70 |
| Nonfat Dry Milk Powder (NFDM) | 46 | |
| Low Glycemic Syrup- LGS | 37 | 0.90 |
| Maltitol Syrup- Maltidex 16311 | 50 | 0.85 |
| Eryrthritol (powder)- Eridex 16952 | 9 | 2.40 |
| Isomalt (powder)- Isomaltidex 16500 | 9 | 1.00 |

Value of Individual Ice Cream Samples

| | Glycemic | Freezing |
|---|---|---|
| Sample | Index | Point (° F.) |
| Control One | 70.1 | 27.3 |
| Control Two | 35.5 | 27.2 |
| Trial 1- LGS | 39.0 | 26.8 |
| Trial 2- LGS + Maltitol | 43.8 | 24.9 |
| Trial 3- LGS + Maltitol + Erythritol | 37.5 | 28.7 |

c. Discussion. Overall, the objective of glycemic value reduction of sample ice cream samples to a value below 40 was achieved in three of the four samples. The exception was Sample #2, which had a value of 43.8, which still represents a significant reduction in glycemic value from full sugar (Control One). With regard to freezing point, all samples appeared and possessed a similar mouthfeel during freezing.

d. Nutrition and Glycemic Index Comparison

Samples of some of the ice creams made were tested for nutrition and glycemic index. The results appear below in Table 7.5.

TABLE 7.5
Nutrition and Glycemic Index Comparison - Ice Creams

| | | | | | Dietary | | Sugar | | | | |
|---|---|---|---|---|---|---|---|---|---|---|---|
| | Serving | | Fat | CHO | Fiber | Sugars | Alcohols | Protein | GI | Net | GL (per |
| Product | (g) | Calories | (g) | (g) | (g) | (g) | (g) | (g) | (Calculated) | CHO | serving) |
| Vanilla Ice | 68 | 140 | 7 | 16 | 0 | 14 | 0 | 3 | 75 | 16 | 12 |
| Cream | | | | | | | | | | | |
| (Control One) | | | | | | | | | | | |
| Vanilla Ice | 68 | 140 | 7 | 17 | 0 | 10 | 0 | 3 | 39 | 17 | 7 |
| Cream (LGS) | | | | | | | | | | | |
| Vanilla Ice | 68 | 130 | 7 | 17 | 0 | 7 | 6 | 3 | 44 | 11 | 5 |
| Cream | | | | | | | | | | | |
| (LGS + Maltitol) | | | | | | | | | | | |

F. Other Food Products Using LGS

1. Gummy Candy

The control gummy candy has 21.6% water, 5.4% gelatin, 49% corn syrup (63DE, 80% dry solid), 24% sugar. The low glycemic gummy candy has 21.6% water, 5.4% gelatin, and 58% LGS (made with 9:1 ratio of sucrose and maltose, at 80% dry solid). The low glycemic candy has a 59% reduction in calculated glycemic index as compared to control.

2. Caramels

The control caramel has 37% sweetened condensed whole milk, 21% sugar, 14.1% butter, 26.9% corn syrup (62DE, 80% dry solid), 0.76% emulsifier, 0.1% salt, 0.1% sodium bicarbonate, 0.04% vanillin. The low glycemic caramel has 35.5% sweetened condensed whole milk, 51% LGS (made with 9:1 ratio of sucrose and maltose, at 80% dry solid), 13.5% butter, 0.76% GMS, 0.1% salt, 0.1% sodium bicarbonate, 0.04% vanillin. The low glycemic caramel has a 42% reduction in calculated glycemic index as the control.

3. Maple Flavored Syrup

The control maple syrup contains 59.2% high fructose corn syrup (42HFCS, 71% dry solid), 34.7% corn syrup (43DE, 81% dry solid), 5.2% water, 0.85% maple flavor, and 0.05% potassium sorbate. The low glycemic maple sweetener has 87.5% LGS (made with 9:1 ratio of sucrose and maltose, at 80% dry solid), 11.15% water, 0.85% maple flavor and 0.05% potassium sorbate. The low glycemic maple syrup has a 54% reduction in calculated glycemic index as compared to control.

4. Ketchup

The control ketchup has 39.4% tomato paste, 24.3% water 16.6% high fructose corn syrup (42HFCS, 71% dry solid), 9% corn syrup (63 DE, 80% dry solid), 8.7% vinegar, 1.9% salt, 0.15% onion powder, and 0.03% garlic powder. The low glycemic ketchup contains 39.4% tomato paste, 26.1% water, 23.7% LGS (made with 9:1 ratio of sucrose and maltose, at 80% dry solid), 8.7% vinegar, 1.9% salt, 0.15% onion powder, and 0.03% garlic powder. The low glycemic ketchup has a 46% reduction in calculated glycemic index.

5. Chocolate Chip Cookies

The control cookies are made of 31.6% flour, 23.7% sugar, 18.9% shortening, 2.2% egg solids, 5.4% water, 0.4% salt, 0.2% sodium bicarbonate, 0.3% flavor, and 17.4% chocolate chips. The low glycemic cookies contain 31.4% flour, 29.4% LGS (made with 9:1 ratio of sucrose and maltose, at 80% dry solid), 18.8% shortening, 2.2% egg solids, 0.4% salt, 0.2% sodium bicarbonate, 0.3% flavor, and 17.3% chocolate chips. The low glycemic cookies have a 16% reduction in calculated glycemic index as compared to the control.

6. French Dressing

| | | | | |
|---|---|---|---|---|
| | Amount | | | |
| | (as/is | | | Glycemic |
| Formula (%) | basis) | Sugar (%) | Sweetness | Index |

A. Example of a dressing control formula

| | | | | |
|---|---|---|---|---|
| Soybean Oil | 36.000 | — | — | — |
| Water | 24.362 | — | — | — |
| HFCS 42% | 20.268 | 14.39028 | 24.3216 | 14.39028 |
| Sugar | 2.000 | 2 | 2 | 1.36 |
| Cider Vinegar- 50 grain | 6.910 | — | — | — |
| Tomato Paste | 3.300 | 0.4 | — | 0.152 |
| White Vinegar, 120 grain | 2.060 | — | — | — |
| Salt | 2.800 | — | — | — |
| Starch | 0.900 | — | — | — |
| Mustard Blend | 0.350 | — | — | — |
| Onion Powder | 0.300 | — | — | — |
| Garlic Flavor | 0.199 | — | — | — |
| Ketchup Flavor | 0.199 | — | — | — |
| Xanthan Gum | 0.190 | — | — | — |
| Phosphoric Acid | 0.100 | — | — | — |
| Lime Juice Flavor | 0.025 | — | — | — |
| Guar Gum | 0.010 | — | — | — |
| Lemon Juice Solids | 0.010 | — | — | — |
| Red #40, 00401 | 0.010 | — | — | — |
| Calcium Disodlum EDTA | 0.007 | — | — | — |
| TOTAL | 100.000 | 16.79 | 26.32 | 94.71 |

B. Example of a dressing with low glycemic value using LGS

| | | | | |
|---|---|---|---|---|
| Soybean Oil | 36.000 | — | — | — |
| Water | 24.362 | — | — | — |
| Low Glycemic Syrup | 22.268 | 15.81028 | 26.7216 | 8.23916 |
| Cider Vinegar- 50 grain | 6.910 | 6.91 | 6.91 | 4.6988 |
| Tomato Paste | 3.300 | 0.4 | — | 0.7828 |
| White Vinegar, 120 grain | 2.060 | — | — | — |
| Salt | 2.800 | — | — | — |
| Starch | 0.900 | — | — | — |
| Mustard Blend | 0.350 | — | — | — |
| Onion Powder | 0.300 | — | — | — |
| Garlic Flavor | 0.199 | — | — | — |
| Ketchup Flavor | 0.199 | — | — | — |
| Xanthan Gum | 0.190 | — | — | — |
| Phosphoric Acid | 0.100 | — | — | — |
| Lime Juice Flavor | 0.025 | — | — | — |
| Guar Gum | 0.010 | — | — | — |
| Lemon Juice Solids | 0.010 | — | — | — |
| Red #40, 00401 | 0.010 | — | — | — |
| Calcium Disodium EDTA | 0.007 | — | — | — |
| TOTAL | 100.000 | 23.12 | 33.63 | 59.35 |

7. Low Glycemic Honey Replacer

Low glycemic honey is prepared by thoroughly mixing 57% (all wt/wt) of LGS, 34.07% of Special Fx TM 90% fructose (Cargill, Inc.), 8% clover honey, 0.05% Trehalose, 0.03% Citric Acid Anhydrous, 0.03% Ascorbic Acid, 0.02% Caramel Color (Sethness RT240), and 0.8% honey flavor.

8. Nutrition and Glycemic Index Comparison

Samples of some of the other products made were tested for nutrition and glycemic index. The results appear below in Table 7.6.

TABLE 7.6
Nutrition and Glycemic Index Comparison - Other Products

| | | | | | Dietary | | Sugar | | | | |
|---|---|---|---|---|---|---|---|---|---|---|---|
| | Serving | | Fat | CHO | Fiber | Sugars | Alcohols | Protein | GI | Net | GL (per |
| Product | (g) | Calories | (g) | (g) | (g) | (g) | (g) | (g) | (Calculated) | CHO | serving) |
| French | 29 | 120 | 10 | 6 | 0 | 6 | 0 | 0 | 60 | 6 | 4 |
| Dressing | | | | | | | | | | | |
| (Control) | | | | | | | | | | | |
| French | 29 | 120 | 10 | 6 | 0 | 3 | 0 | 0 | 38 | 6 | 2 |
| Dressing | | | | | | | | | | | |
| (LGS) | | | | | | | | | | | |
| Ketchup | 17 | 20 | 0 | 5 | 0 | 4 | 0 | 0 | 57 | 5 | 3 |
| (Control) | | | | | | | | | | | |
| Ketchup | 17 | 20 | 0 | 5 | 0 | 3 | 0 | 0 | 33 | 5 | 2 |
| (LGS) | | | | | | | | | | | |
| Maple | 30 ml | 80 | 0 | 21 | 0 | 15 | 0 | 0 | 80 | 21 | 17 |
| Flavored | | | | | | | | | | | |
| Pancake | | | | | | | | | | | |
| Syrup | | | | | | | | | | | |
| (Control) | | | | | | | | | | | |
| Maple | 30 ml | 80 | 0 | 21 | 0 | 11 | 0 | 0 | 46 | 21 | 10 |
| Flavored | | | | | | | | | | | |
| Pancake | | | | | | | | | | | |
| Syrup (LGS) | | | | | | | | | | | |

This invention has been described above in detail with particular reference to preferred embodiments thereof, but it will be understood that variations and modifications other than as specifically described herein can be effected within the spirit and scope of the invention. Moreover, all patents, patent applications, provisional patent applications, and literature references cited above are incorporated hereby by reference for any disclosure pertinent to the practice of this invention.

What is claimed is:

1. A process for preparing a low glycemic index food or beverage composition comprising:
incorporating into a food or beverage composition a low glycemic sweetener; and
incorporating into the food or beverage at least one or more sweeteners selected from the group consisting of conventional sweeteners, high intensity sweeteners and sugar alcohols.

2. A process according to claim 1, further comprising incorporating a vitamin into the food or beverage.

3. A process according to claim 1, further comprising incorporating a mineral into the food or beverage.

4. A composition comprising at least one LGS and at least one sweetener selected from the group consisting of sugar alcohols, conventional sweeteners and high intensity sweeteners.

5. The composition of claim 4, wherein the composition has a glycemic index at least 10% lower than a similar composition excluding the low-glycemic sweetener.

6. A composition comprising at least one LGS and at least one vitamin.

7. A composition comprising at least one LGS and at least one mineral.

8. A process for producing a low glycemic sweetener, comprising reacting sucrose, an acceptor, and a glucansucrase enzyme.

9. The process of claim 7, wherein the acceptor is a sugar or sugar alcohol having free hydroxyl groups at one or more carbon position numbers 2, 3, or 6.

10. A low glycemic sweetener, comprising fructose and glucose oligosaccharide.
